(19) United States
(12) Patent Application Publication
(10) Pub. No.: US 2026/0201928 A1
(43) Pub. Date: Jul. 16, 2026

(54) ELECTROMECHANICALLY ACTUATED DRUM BRAKE

(71) Applicant: Robert Bosch GmbH, Stuttgart (DE)

(72) Inventors: Andreas Illmann, Weil Der Stadt (DE); Raed Hamada, Stuttgart (DE); Simon Trautmann, Stuttgart (DE); Simon Peter, Weil Der Stadt (DE)

(21) Appl. No.: 19/441,034

(22) Filed: Jan. 6, 2026

(30) Foreign Application Priority Data
Jan. 13, 2025 (DE) 10 2025 100 932.5

(51) Int. Cl. F16D 51/22; F16D 65/22; F16D 121/24; F16D 125/30

(52) U.S. Cl. CPC F16D 51/22; F16D 65/22; F16D 2121/24; F16D 2125/30

(57) ABSTRACT

An electromechanically actuated drum brake for a motor vehicle/The drum brake includes: brake shoes that are mounted on the front side of a rear part of the drum brake; an adjustment device arranged between the brake shoes, wherein the adjustment device is arranged in a housing, and spreads the brake shoes for braking by means of a rotational movement of a rotational axis that is supported by a bearing. The housing of the adjustment device is connected to the rear part of the drum brake and the bearing of the adjustment device is arranged in the housing.

### CROSS REFERENCE

The present application claims the benefit under 35 U.S.C. § 119 of Germany Patent Application No. DE 10 2025 100 932.5 filed on Jan. 13, 2025, which is expressly incorporated herein by reference in its entirety.

### FIELD

The present disclosure relates to an electromechanically actuated drum brake for a motor vehicle.

### BACKGROUND INFORMATION

In modern vehicles, drum brakes with various types of actuation may be used. Typically, drum brakes are hydraulically actuated. In this process, hydraulic pressure is built up in a twin piston, forcing it apart, as a result of which a force is exerted on each brake shoe of the drum brake. The brake shoes are frequently roughly positioned by a support bearing and return springs and can find their position within the drum automatically according to tolerances and the wear condition.

Germany Patent Application No. DE 10 2008 051 254 A1 describes an electromechanical drum brake with an S-shaped cam for actuating brake shoes. For rotating the cam, a direct-current motor is provided, the driven shaft of which is connected via a three-stage gear unit to a camshaft, which in turn drives the cam directly or indirectly. The three gear unit stages are accommodated in a gear unit housing. The input shaft of the first gear unit stage is rotationally fixed to the driven shaft, and the output shaft of the third gear unit stage is rotationally fixed to the camshaft.

### SUMMARY

The present disclosure relates to an electromechanically actuated drum brake for a motor vehicle, having the following components:
Brake shoes that are mounted on the front side of a rear part of the drum brake.
An adjustment device arranged between the brake shoes, wherein the adjustment device
   is arranged in a housing, and
   spreads the brake shoes for braking by means of a rotational movement of a rotational axis that is supported by a bearing.

In accordance with the present disclosure, the housing of the adjustment device is connected to the rear part of the drum brake and the bearing of the adjustment device is arranged in the housing.

In an advantageous embodiment, the adjustment device comprises an S-shaped cam.

The bearing of the adjustment device or the S-camshaft must absorb large forces during braking. Therefore, it is advantageous if the bearing is located in the housing that is at least connected to the housing of the entire actuator.

The connection according to the present disclosure of the rear part or rear plate of the drum brake and a preferably pre-assembled EMB actuator having an integrated S-cam bearing optimizes the requirements for use in passenger motor vehicles.

According to an example embodiment, it is particularly advantageous that the rear part of the drum brake is adapted to the housing of the adjustment device in such a way that the housing is press-fitted into the rear side of the rear part. Here, it can also be provided that the press-fitted housing is additionally screwed to the rear part.

Due to the press-fitting and optionally also due to the screw connection, it is ensured that the position of the adjustment device/the cam is centered and positioned with respect to the brake shoes. The brake shoes are clearly positioned relative to the rear part or rear plate in a conventional manner by means of a support bearing.

Axial securing is achieved by a form fit between the rear plate and the actuator housing at the dome.

Furthermore, according to an example embodiment, it can be provided that the rear part comprises, at the location at which the housing of the adjustment device is press-fitted, a dome-shaped protrusion aligned toward the front side of the rear part.

The bearing is advantageously supported against the housing in the region of the dome-shaped protrusion. Furthermore, the rear part can be made of sheet metal. The dome-shaped protrusion can be formed by stamping and deep drawing the rear part from sheet metal.

Due to this dome-shaped portion, the rear part can comprise a relatively thin wall and therefore be relatively flexible. In order to still be able to absorb high bearing forces, in this embodiment of the present disclosure the rear part forms the dome at the location of the bearing, which dome takes over the force transmission directly into the rear plate at the bearing location. In addition, the rear part is supported in this region from behind by the surface-area screw connection to the housing. As a result, it is ensured that the rear plate can absorb high forces without being plastically deformed.

In a further embodiment of the present disclosure, a centering pin is provided by means of which the housing is positioned on the rear part. This has the particular advantage that the connection between the rear plate and the housing has only minimal tolerances. It is particularly advantageous that the centering pin is firmly connected to the housing or is formed as part of the housing and a guide for the centering pin is provided in the rear part. The centering pin is advantageously arranged in the vicinity of the dome-shaped protrusion.

For optimized axial fixing of the housing to the rear part, an edge is provided on the housing at the transition from the housing to the rear part in the region of the dome-shaped protrusion.

Overall, in accordance with the present disclosure, the rear plate is designed in such a way that
the correct positioning of the actuator relative to the base brake and thus the centering of the S-cam between the brake shoes is ensured,
the high bearing forces occurring at the S-cam can be absorbed,
the flexibility of the rear plate can be advantageously utilized,
the rear plate can be produced cost-effectively as a deep-drawn and stamped sheet metal, and
the pre-assembly of the actuator and its simple integration into the base brake are possible.

Further embodiments of the present disclosure can be found in the disclosure herein.

Exemplary embodiments of the present disclosure are explained in more detail in the following description and are illustrated in the figures.

### BRIEF DESCRIPTION OF THE DRAWINGS

FIG. 1 shows an electromotively/electromechanically actuatable drum brake according to an exemplary embodiment of the present disclosure.

FIG. 2 is a representation of a drive unit and the cam according to an exemplary embodiment of the present disclosure.

FIG. 3 is an exploded view of an actuator.

FIG. 4 is an enlarged view of the interface between the rear plate and the actuator with and without brake shoes.

FIG. 5 is a sectional view through an S-camshaft.

FIG. 6 is a detailed view of the rear plate.

FIG. 7 is a detailed view of the actuator.

FIG. 8 is a sectional view with a centering pin.

FIG. 9 is a sectional image with axial fixation.

FIG. 10 shows an actuator with a centering pin.

### DETAILED DESCRIPTION OF EXAMPLE EMBODIMENTS

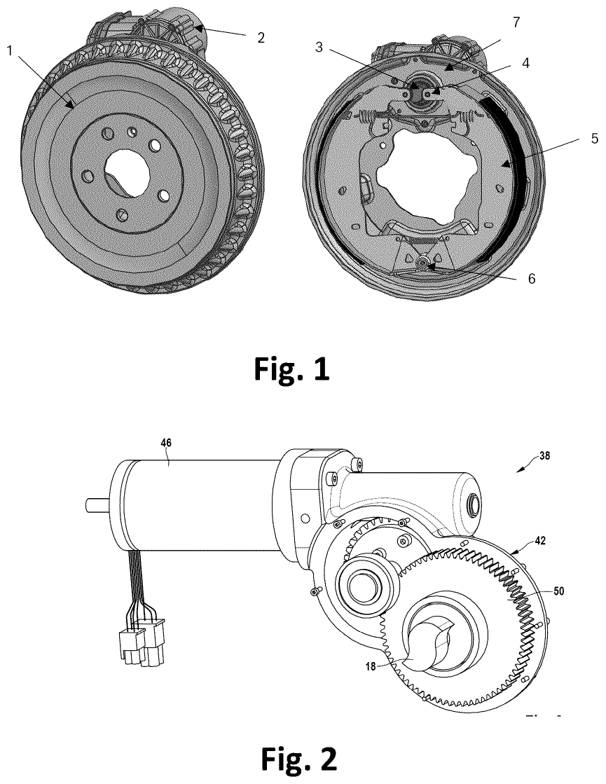

FIG. 1 shows by way of example an electromechanical drum brake including an actuator 2 and the base brake 1. In this embodiment according to the present disclosure, the electromechanical actuator 2 rotates an S-shaped cam 3. Rollers 4 run on the cam 3 and transmit the spreading movement to the brake shoes 5. Due to the spreading movement, the shoes 5 and thus the brake linings are pressed against the drum, thereby generating the braking torque. The shoes 5 are supported at the bottom on the support bearing 6 and are positioned by the rear plate 7 and the springs shown.

The present disclosure relates to the embodiment of the rear plate 7 and the integration of the actuator 2 into the base brake 1.

FIG. 2 shows a representation of a drive unit 38 and the cam 18 according to an exemplary embodiment of the present disclosure. The drive unit 38 comprises a gear unit 42 that, after the rotational speed of an electric motor 46 of the drive unit 38 is reduced, drives the cam 18. In the exemplary embodiment shown, the gear unit 42 comprises straight-toothed spur gears 50, by means of which noise generation of the gear unit 42 can be reduced. Likewise, such straight-toothed spur gears 50 can be produced economically.

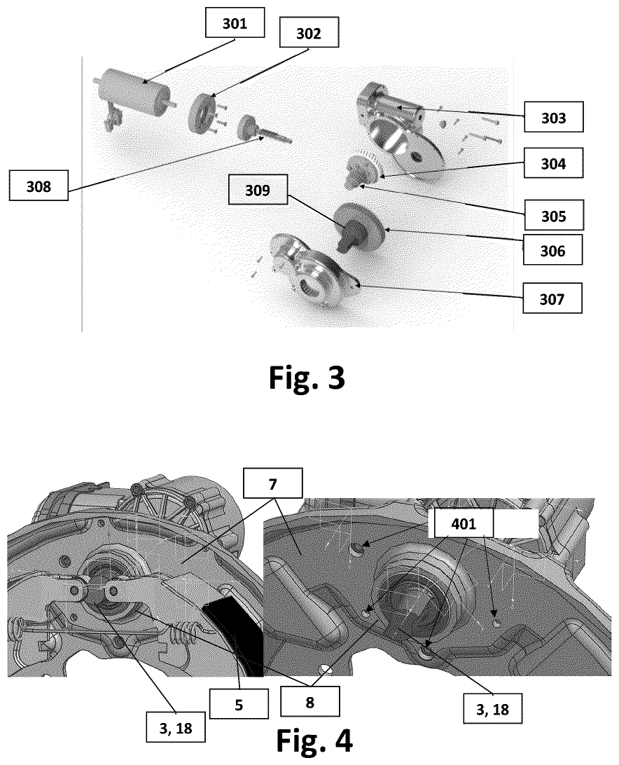

FIG. 3 shows the actuator 38 in an exploded view. The electric motor 301 drives a helical gear 304 via a worm 308 connected by a motor flange 302. The rotation of the helical gear 304 is further translated through a spur gear stage 305 and transmitted to the camshaft 309 as part of the adjustment device. In a preferred design, the worm gear may be made of plastics (POM). As a result, a particularly cost-effective design and low noise generation are to be expected. The spur gear stage 306, which is fastened to the camshaft 309, undergoes only relatively small rotational movements, since the maximum rotation angle of the cam is <180°. Therefore, a straight-toothed spur gear pairing can preferably be selected in order to avoid axial forces on the camshaft without causing problematic noise generation. Reference sign 307 denotes the first part of the housing and reference sign 303 denotes the second part of the housing of the adjustment device 309.

FIG. 4 shows an enlarged view of the interface between the rear plate and the actuator with (FIG. 4/left side) and without brake shoes (FIG. 4/right side). That is, FIG. 4 shows the region in which the actuator 38 is connected to the rear plate 7. The actuator 38 is press-fitted into the rear plate 7 from behind and screwed to it at the mounting points 401. The position of the cam 18 with respect to the brake shoes 5 is ensured in that the actuator housing or the housing 307/303 of the adjustment device is centered and positioned relative to the rear plate 7 by the press-fitting. The brake shoes are clearly positioned relative to the rear plate by means of the support bearing 6 (FIG. 1).

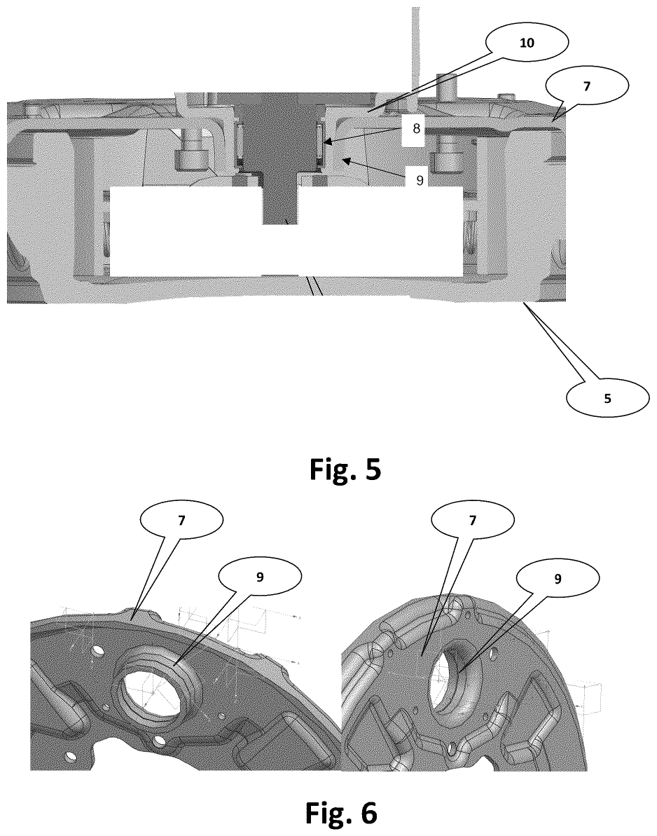

FIG. 5 shows a sectional view through the S-camshaft. In this view, it can be seen that the bearing 8 of the S-camshaft, which must absorb large forces acting on the S-cam during braking, is located in the housing 10 or 303/307 of the actuator. The bearing 8 is shown here by way of example as a needle bearing; alternatively, sliding bearings or other rolling bearing configurations are also possible. The white-marked central portion of FIG. 5 is not necessary for understanding the present disclosure.

In commercial vehicles with pneumatic S-cam brakes, such bearings are generally accommodated directly in the wheel carrier. This is not desirable for the application case of passenger vehicles, since it leads to additional complexity of the wheel carrier and also makes pre-assembly of the actuator unit more difficult. In addition, a certain flexibility of the actuator mounting is advantageous in order to slightly increase the braking coefficient during very strong actuation (e.g., fading) and to dampen the effects of external accelerations on the actuator (e.g., when driving over potholes). This is made possible by the fact that the rear plate 7 has a relatively thin wall (e.g., 3-5 mm) and is therefore flexible.

In order nevertheless to be able to absorb high bearing forces, the rear plate 7 forms a dome 9 at the location of the bearing 8, which dome takes over the force transmission directly into the rear plate 7 at the bearing location. In addition, in this region the rear plate 7 is supported from behind by the surface-area screw connection to the actuator housing shown in FIG. 4. As a result, it is ensured that the rear plate 7 can also absorb high forces without becoming plastically deformed.

Due to the relatively thin wall thickness of the rear plate 7 and its shaping, it can be produced cost-effectively by stamping and deep drawing from sheet metal. In the assembly process, due to the design of the connection between the rear plate 7 and the actuator 38, it is possible for the actuator 38 to be pre-assembled and tested as a fully functional unit and to be connected to the base brake at a later point in time, e.g. during final vehicle assembly.

FIG. 6 shows a detailed view of the rear plate 7 with the dome-shaped protrusion 8.

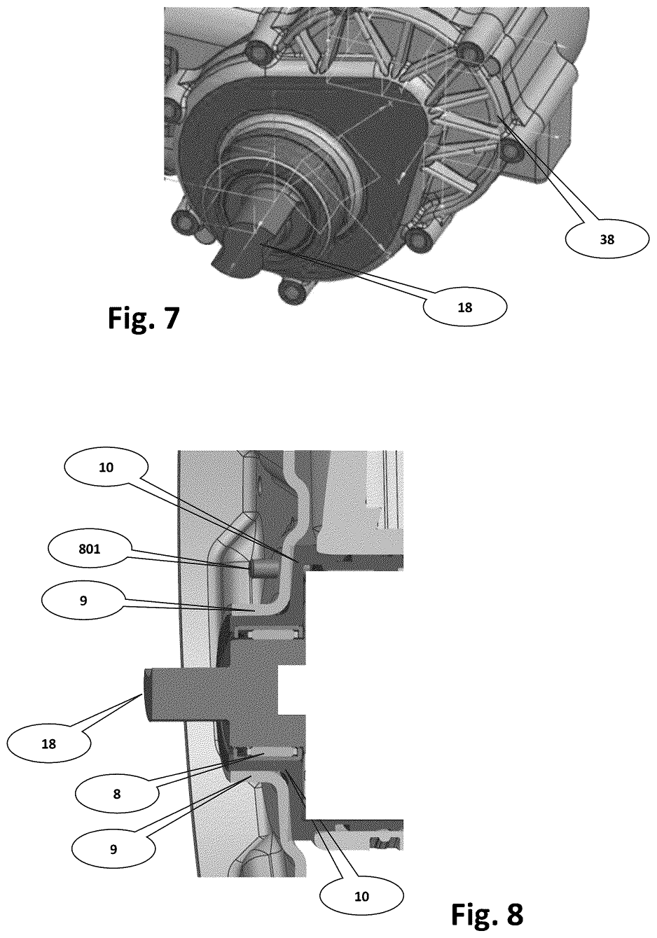

FIG. 7 provides a detailed view of the actuator in the region that is connected to the rear plate 7 in the assembled state.

FIG. 8 shows a sectional view similar to that in FIG. 5, but with a centering pin 801. The centering pin 801 serves to ensure that the actuator housing 10 is positioned radially to fit precisely on the rear part 7, in particular in the dome 9. The white-marked right central portion of FIG. 8 is not necessary for understanding the present disclosure.

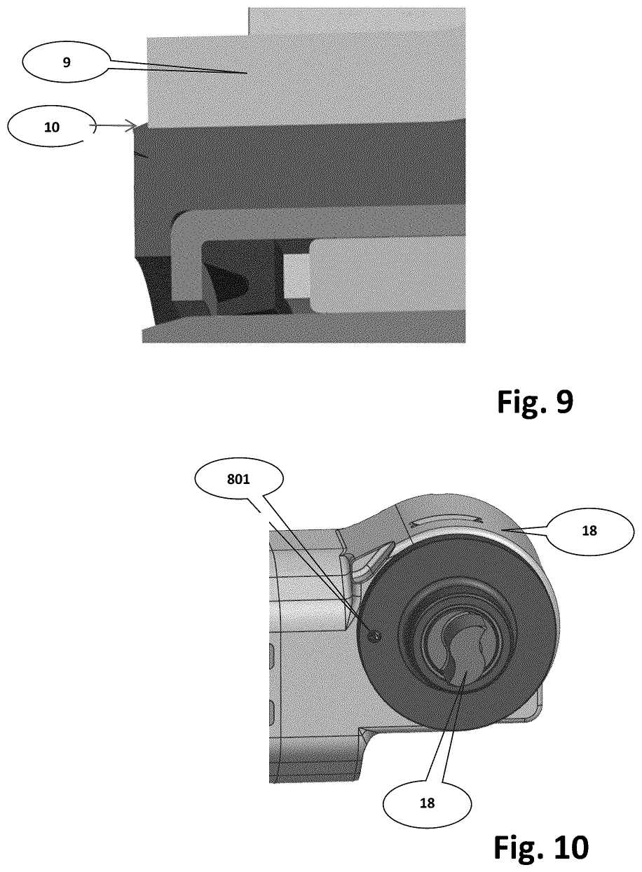

As can be seen in FIG. 9, the centering pin 801 is firmly connected to the housing 10 or formed as part of the housing 10. A guide for the centering pin 801 is then provided in the rear part 7.

FIG. 9 shows the axial fixation of the housing 10 to the rear part 7 by means of an edge at the end of the housing dome. Alternatively, axial guidance can be ensured with screws, retaining rings or similar devices.

### REFERENCE SIGNS

1: Actuator
2: Base brake
3: S-shaped cam
4: Rollers
5: Brake shoes
6: Support bearing
7: Rear plate
8: Bearing
9: Dome/rear plate
10: Actuator housing
18: Cam
38: Drive unit (actuator)
42: Gear unit
46: Electric motor
50: Toothed spur gear
301: Motor
302: Motor flange
303: First housing
304: Helical gear
305: First spur gear
306: Second spur gear
307: Second housing
308: Worm gear set
309: Adjustment device
401: Mounting points
801: Centering pin

What is claimed is:

1. An electromechanically actuated drum brake for a motor vehicle, comprising:
brake shoes that are mounted on a front side of a rear part of the drum brake; and
an adjustment device arranged between the brake shoes, wherein the adjustment device is arranged in a housing, and is configured to spread the brake shoes for braking using a rotational movement of a rotational axis that is supported by a bearing;
wherein the housing is connected to the rear part and the bearing is arranged in the housing.

2. The electromechanically actuated drum brake according to claim 1, wherein the adjustment device includes an S-shaped cam.

3. The electromechanically actuated drum brake according to claim 1, wherein the rear part is adapted to the housing in such a way that the housing is press-fitted into the rear side of the rear part.

4. The electromechanically actuated drum brake according to claim 3, wherein the press-fitted housing is screwed to the rear part.

5. The electromechanically actuated drum brake according to claim 3, wherein the rear part includes, at a location at which the housing of the adjustment device is press-fitted, a dome-shaped protrusion aligned toward the front side.

6. The electromechanically actuated drum brake according to claim 5, wherein in a region of the dome-shaped protrusion, the bearing is supported against the housing.

7. The electromechanically actuated drum brake according to claim 1, wherein the rear part is made of sheet metal.

8. The electromechanically actuated drum brake according to claim 5, wherein the dome-shaped protrusion is formed by stamping and deep drawing the rear part from sheet metal.

9. The electromechanically actuated drum brake according to claim 1, further comprising a centering pin using which the housing is positioned on the rear part.

10. The electromechanically actuated drum brake according to claim 9, wherein the centering pin is firmly connected to the housing or is formed as part of the housing, and a guide for the centering pin is provided in the rear part.

11. The electromechanically actuated drum brake according to claims 5, further comprising a centering pin using which the housing is positioned on the rear part, wherein the centering pin is arranged in a vicinity of the dome-shaped protrusion.

12. The electromechanically actuated drum brake according to claim 5, wherein an edge is provided on the housing at a transition from the housing to the rear part in a region of the dome-shaped protrusion.
